(19) United States
(12) Patent Application Publication
(10) Pub. No.: US 2001/0029186 A1
(43) Pub. Date: Oct. 11, 2001

(54) Massively parallel cordless telephone network

(76) Inventors: James Canyon, San Diego, CA (US); Nancy Canyon, San Diego, CA (US)

Correspondence Address: James Canyon, 11496 Meadow Grass Lane, San Diego, CA, 92128, US

(21) Appl. No.: 09/768,021

(22) Filed: Jan. 23, 2001

Related U.S. Application Data
(60) Provisional application No. 60/177,777, filed on Jan. 24, 2000.

(51) Int. Cl. H04Q 7/20

(52) U.S. Cl. 455/462; 455/463; 455/465; 455/426

(57) ABSTRACT

An apparatus and method for providing a massively parallel wireless network for data and telephony comprised of a plurality of base station devices which are owned and operated by consumers and businesses across an area. The base station devices connect to a landline network and communicate wirelessly with a plurality of wireless handsets. Each handset can communicate with any of the base stations in the network. To place a call (or access data), a handset communicates with a nearby base station on a polling channel. The handset determines the strongest station signal and thereafter uses a designated channel to place calls through the landline connection via the base station.

### RELATED APPLICATIONS

The present application claims priority of Provisional application entitled “Worldwide Home/Business Data and Wireless Telephone Terminal,” filed on Jan. 24, 2000, by the inventors Canyon et al., and assigned Ser. No. 60/177,777, which is hereby incorporated by reference in its entirety.

### FIELD OF THE INVENTION

A massively parallel cordless telephone network, with associated handsets which will have the ability to place calls and provide data services through all associated based stations in the network.

### BACKGROUND OF THE INVENTION

The consumer telephony and data service market has been and is projected to be ever growing through 2010 (and beyond) with the Internet being one key application. At odds are the “baby bells,” long distance companies, cable companies and others competing for this crowded market share. Products competing in this field include POTS, Cellular, DSL, cable modems, satellites, and others.

Telephony, again primarily dominated by baby bells and long distance carriers, is being challenged by other forms of wireless communication such as cell phones. As demand rises for such services, so does the requirement for increased density of cellular telephony and TDMA/CDMA/PCS type equipment.

FIG. 1 shows a representative depiction 100 of the telecommunications landscape today. Various homes (and/or businesses) 102, 104, and 106 receive services such as telephone and television. Either such device might interact with a computer. Examples of cable networks 108 are shown serving the homes via splitters 110. These might include representative technology such as analog video, digital video, cable modem, and telephone. Additionally, Telephone (or “Bell”) Networks 112 are shown serving the homes via switching stations 114. These might include representative technology such as telephone, ISDN, or DSL. A cellular network 116 is shown with a handset 118 and user 120. Cellular networks might include AMPS, CDMA, TDMA, GSM, PCS, and Paging. A satellite network 122 is further shown, and might include representative technology such as Hughes network video, dish video, global star and telephony data, irridium telephony, teledesic data, and paging data.

Telephone networks are pressed to capacity in most cases. Moreover DSL is gradually less effective for users located far from the optical line. Cable networks suffer from limited bandwidth as more and more users in one area use the system. Installation of new systems to improve the density of coverage proves to be expensive in most cases. A cellular network requires the installation of more cellular stations to handle the increasing density of calls in any given area. Satellites are by their nature extremely expensive to build, launch and maintain. Certain companies are addressing transmission and multiplexing techniques to further increase the density of cellular users (e.g., “littlefeet inc” best known as pico-cell technology).

According what is needed in the field of art is a system that provides an operable network that operates in conjunction with existing networks, but grows with each new user that joins the network. This solution might come in the form of a massively parallel cordless telephone network that will allow individual handsets to communicate through any of a number of base stations in the associated network. Such a system would thereby provide for a telephone network that will continue to grow as new base stations are added by users of the system, with these base stations being purchased and added by new users of the system.

### SUMMARY OF THE INVENTION

The present invention provides for creation of a nation/world wide standard cordless telephone network whereby all handsets will have the ability to place calls through all base stations. Consumer owned and operated base stations will interface directly to the service provider using the standard telephony protocol and operating within (for instance) the unlicensed band 902-928 MHz in the United States. The base stations, once installed, will initiate conversations with other base stations via wireless transmission. Groups of base stations, called a pod, will automatically form based on signal strength, number of users, and number of interfaces to the service provider. Once formed, the pod will monitor and control handset traffic calls and billing within the area defined by the sum of all of the pod member base stations.

The resulting network is said to be massively parallel because all base stations may act independently or in pods; any one base station within the pod can direct call traffic. The resulting network dramatically improves the existing wired baby bell networks by the addition of a wireless hub at what was originally conceived as the ‘end of the line’. Finally, because now all handsets can talk to all base stations no one handset is dependent on one base station; therefore virtually eliminating any single point failure and improving call throughput through the existing infrastructure.

In particular, Voice over IP (VoIP) provides certain abilities to merge wireless and Internet type technologies into a prioritized packet stream. In parallel with VoIP Development and Data Transmission infrastructure buildout, the present invention provides for IP designed to merge existing cordless telephone technologies with cellular technology and existing consumer home data services. FIG. 2 is a representative chart 200 showing where the present invention—labeled as 202 under an operative tradename “Digital Spring” Analog and VoIP Network—fits into a range of example wireless and telephony data services offered today.

The telephone network described herein is a massively parallel network of consumer owned and operated base stations connected to the consumers data/telephone network of choice. Consumers will purchase these units as they now purchase cordless phones. These base stations differ from existing cordless phone base stations in at least the following ways:

(1) The base stations have the ability to place calls and transmit data to all base stations within the nation wide network.

(2) The base stations have the ability to create communities of base stations which act as a single cell for the purposes of network management. These communities, called ‘pods’ create an area of coverage whose density is directly proportional to the number of users (key feature).

(3) The resulting network will be independent of service provider. This enables a single MPN (Massively Parallel Network) standard nation/world wide.

The Pod, once network configured, is capable of addressing all roaming handsets registered within the network. This additional addressing capability overcomes the existing 10 digit telephone address barrier and will be capable of addressing all users within the network individually. The present system will also provide for uniquely addressable wireless handsets offered for different family (or other group) members.

Accordingly, one aspect of the present invention is an apparatus for providing a wireless communication network in association with a landline network, the apparatus comprising: a plurality of base station transceivers forming a network, each base station having a wireless transceiver and a connection to the landline network; and a plurality of wireless handsets, each of which can communicate with any of the plurality of base stations within range of the handset, wherein the handset establishes communication with a base station and thereby gains communicative access to the associated landline network through the base station connection.

These and other aspects and advantages of the present invention will become apparent upon reading the following detailed descriptions and studying the various figures of the drawings.

### BRIEF DESCRIPTION OF THE DRAWINGS

Certain aspects and advantages of the present invention will be apparent upon reference to the accompanying description when taken in conjunction with the following drawings, which are exemplary, wherein:

FIG. 1 is a block diagram, according to one aspect of the present invention, of a representative architecture of present telecommunications landscape.

FIG. 2 is a block diagram, according to one aspect of the present invention, showing various communication schemes, along with where the present invention fits into such schemes.

FIG. 3 is a block diagram, according to one aspect of the present invention, showing base stations (data service terminals) interacting with wireless handsets.

FIG. 4 is a block diagram, according to one aspect of the present invention, showing representative elements of a data service terminal.

FIG. 5 is a block diagram, according to one aspect of the present invention, showing the evolution of a massively parallel network relative to prior networks.

FIG. 6 is a block diagram, according to one aspect of the present invention, showing a representative polling schematic.

FIG. 7 is a block diagram, according to one aspect of the present invention, showing a representative frequency allocation.

FIG. 8 is a flow chart, according to one aspect of the present invention, showing representative steps of a handset standby mode.

FIG. 9 is a flow chart, according to one aspect of the present invention, showing representative steps of a handset initiating a call mode.

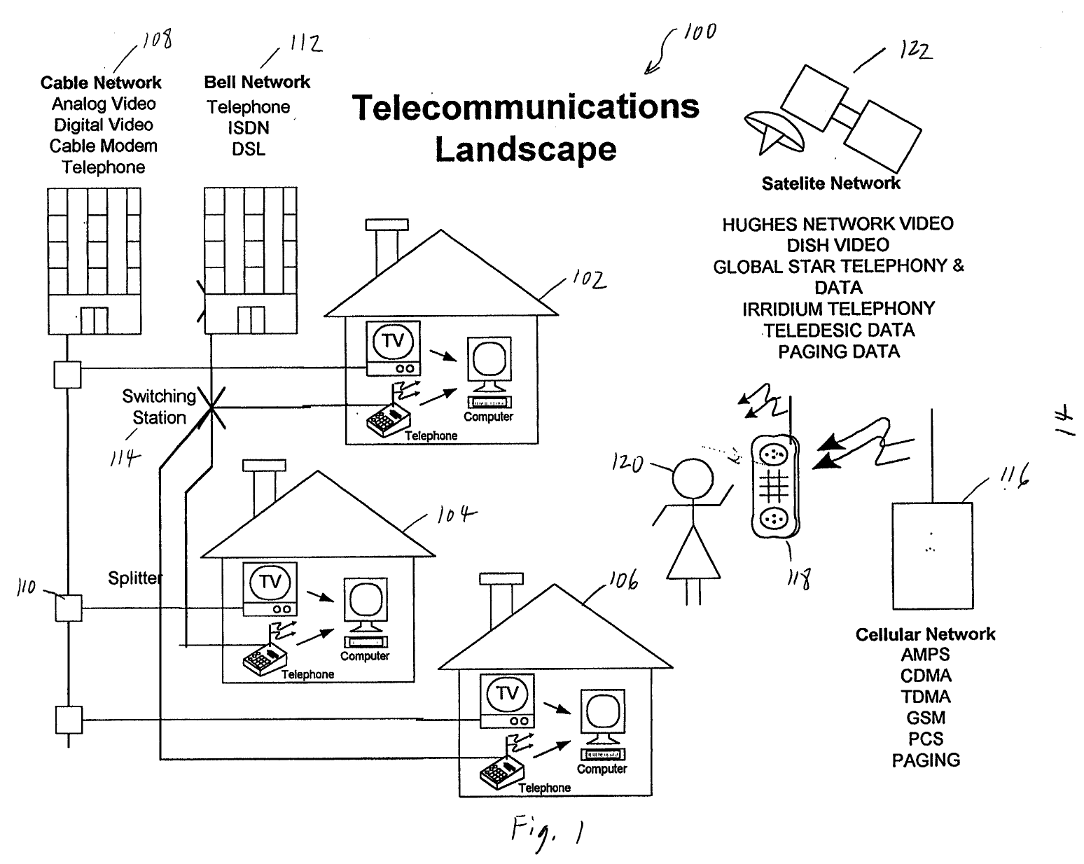

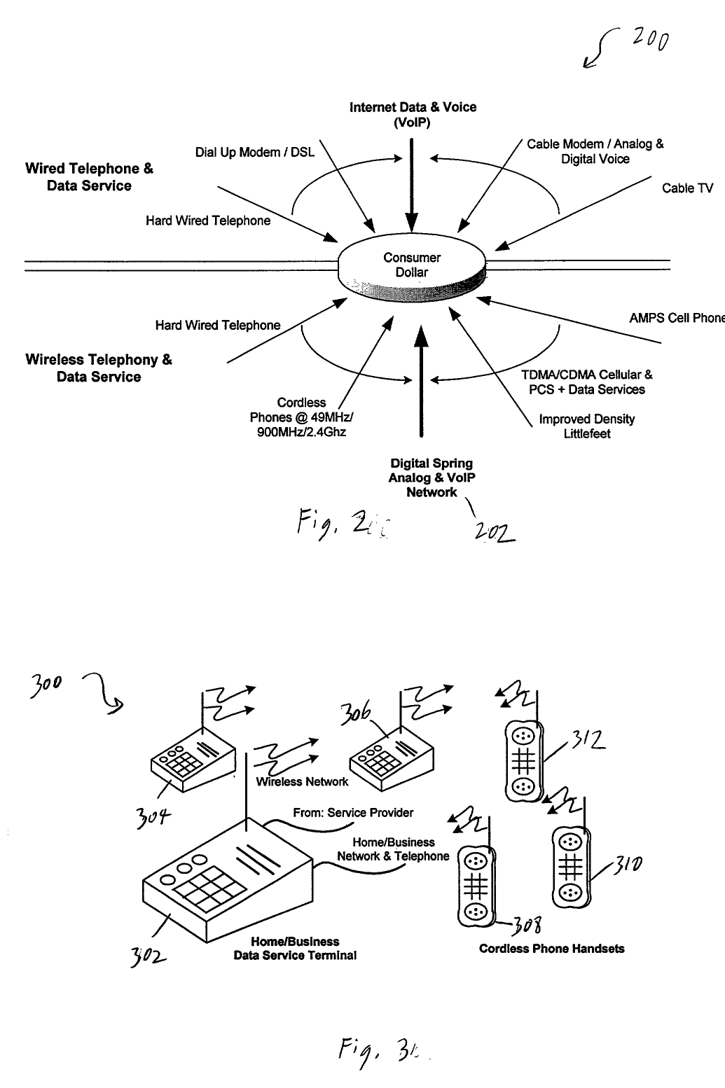

### DESCRIPTION OF THE PREFERRED EMBODIMENTS

The present invention provides at least one apparatus and method for providing a massively parallel cordless telephone network whereby all handsets associated with the system have the ability to place calls through all of the base stations associated with the system. While the examples below are generally described in terms of certain frequency bands and the like, the invention is not meant to be so limited and the principles are widely applicable to other frequency bands and wireless configurations.

An embodiment of the telephone system proposed here is based upon ordinary 900 MHz (or 2.4 GHz) spread spectrum cordless telephone systems, with the following enhancements:

Polling Channel. Cordless telephone handsets and base stations will communicate to each other for purposes of identifying pod boundaries, identifying handset location within the pod, handset location, billing and call initiation using one or more polling channels. Traffic on this channel is also used by the handsets to determine if it is physically located within a pod to enable calls and handset location (for calls placed to the mobile handset).

(a) Pod boundary criteria. Two representative methods are described to define pod boundaries, while the invention is not meant to be limited only these methods. The service provider may select pod boundaries by allocating the base units (via installation procedure) or the base units will have the capability to dynamically reconfigure the pod. This dynamic reconfiguration will be based on number of base units each base can communicate to, signal quality of each base, and pre-loaded statistical data that might be used to grade optimum performance.

(b) Identifying handset location within the pod. Handset location in any wireless network requires handsets to ‘wake up’ and transmit their whereabouts. Handsets will periodically wake up and look to see if a polling channel is within range. If so the handset will ‘register’ it's location to the pod which in turn collects all handset information and relays the information to the network switching center.

(c) Call Initiation. A typical call initiation sequence utilizes the polling channel to find the handset when initiated from the network and to find a base station with an open channel when the call is initiated by the handset.

Billing and Dialing Protocol. Once the handset and base station have been allocated a channel (either frequency, time, or code multiplex) both handset and appropriate base station will switch to the channel prescribed. A dial tone will be heard after both base station and handset switch to the allocated channel. Two suggested options are provided to handle billing within the current telephone network, though others might also be used.

(a) Base Station Selected Billing. Instead of the selected base station handing over a dial tone to the user, the base station automatically dials a service provider such as 1-800 CALL-ATT then prompts the user to dial the telephone number he chooses (note: the billing access number is coded into the phone). This process occurs automatically unbeknowst by the user with the user required only to initially register his phone (to receive his telephone number and the required access code)

(b) Service Provider Selected Billing. Each handset will have a user identification or PIN number, automatically programmed by the service provider. Once a dial tone is initiated, the user dials the number he wishes, The network determines if the call is local or requires further billing. For local calls, no access code is provided. For out of area calls, an access code is appended to the telephone number creating a ‘credit card call’ (1-area code-telephone number-access code).

Note that continuous spectrum throughout the United States is difficult and expensive for any one company to acquire. The FCC has allocated blocks of frequencies open to cordless telephony. These include 46/49 MHz and the unlicensed spread spectrum bands today at 900 MHz, 2.4 GHz, and 5.2 GHz. Since all equipment is owned and operated by consumers, these bands will be open for this type of operation.

The present invention provides for a Appliance that is connected to the existing wired (telephone or cable) infrastructure to supply Data to home/business & worldwide wireless telephone service to subscribers. FIG. 3 shows a representative block diagram 300 of such a system. The network is populated by a plurality of Home/Business Data Service Terminals 302, 304, and 306, and a plurality of cordless phone handsets 308, 310, and 312. The overall Terminal and resulting wireless network consist of the Data Service Terminals (302, 304, 306, etc.) installed at the various homes and businesses. These Terminals interface to the existing wired network and provide both a data port and telephone service to the home/business. In addition to the standard data and telephone services, the data service terminal contains a wireless link to allow communication to any and all wireless handsets (308, 310, 312, etc.) designed for the network.

Data service terminal. The Data Service Terminal consists of a service provider interface, a voice/data multiplexor (to partition voice & data from the service provider interface), an optional home networking combiner (to re-combine the data/voice for transmission through a local home/business network, and a wireless module used to interface the telephone service to the worldwide cordless telephone network.

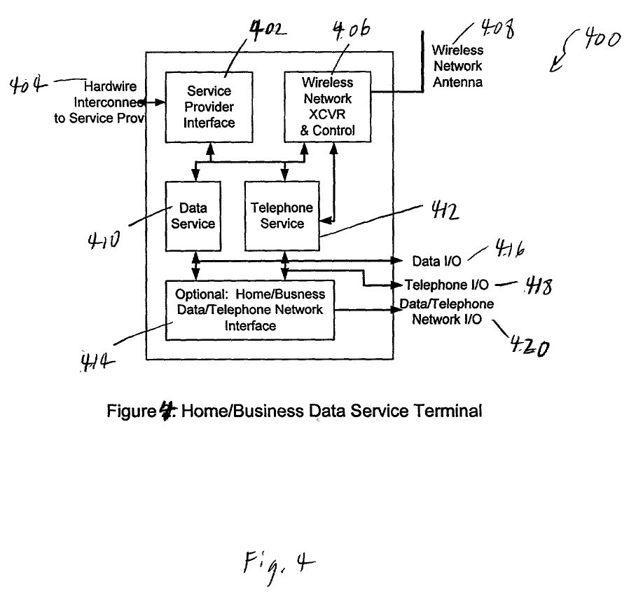

A representative block diagram of the Home/Business Data Service Terminal 400 is as shown in FIG. 4. The terminal 400 is shown to include a service provider interface 402, which includes a hardwire interconnect to a service provider 404. The Data Service Terminal 400 is connected to the service provider through this Service Provider interface. The most popular interfaces today are standard twisted pair, DSL, Cable, and the new wide band wireless standards (i.e. CDMA 3G). Interfaces may be designed to connect one or multiple standards. The interfaces are well defined (with the possible exception of the wide band wireless CDMA 3G standard). Highly integrated parts are available from multiple vendors such as Motorola, Broadcom and Conexant systems.

A wireless network and transceiver control 406 is also provided, and includes a wireless network antenna 408. The wireless network transceiver consists of an audio interface, spread spectrum transceiver and control functions to allow communication to the worldwide standard described by the Massively Parallel Cordless Telephone Network disclosure.

A data service module 410 is provided, along with a telephone service module 412. Each module 410 and 412 is interconnected to communicate (via a bus, hardwire, or the like) with the interface 402 and the control 406. For such data service & telephone service, depending on the standard, voice and data might need to be separated from the service provider interface for interface to the work/home network & telephone. An additional port might be provided to the wireless network controller for wireless telephony. The output format of the data service will generally be an Ethernet format. The output format of the telephone service will generally be a standard two wire telephone interface.

An optional interface 414 is also shown interconnected to the modules 410 and 412. This optional interface might be used for providing a Home/Business Data/Telephone Network Interface for more localized networks. For example, the existing telephone lines within a residence may be used to provide both telephone service and data service administered by the data service terminal. The interface might include a standard 2 wire tip/ring.

Also shown are Input/Output (I/O) lines to their respective modules or interfaces, including an Data I/O 416, a Telephone I/O 418, and a Data/Telephone Network I/O 420.

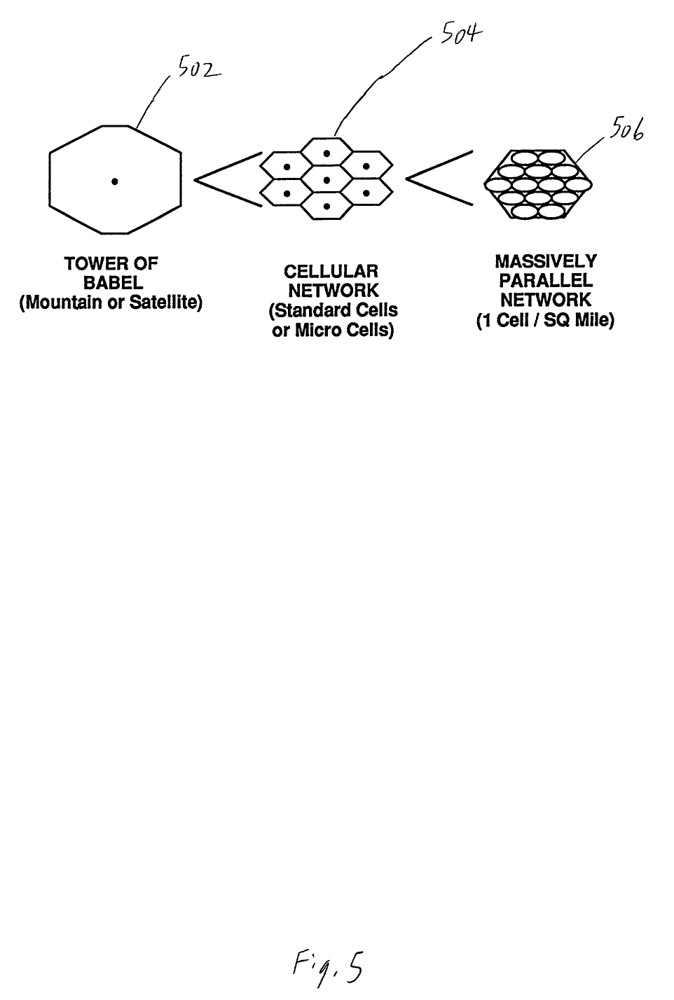

FIG. 5 demonstrates one representative benefit of the present system, as compared with other systems. The broadest transmission system would include an infinite tower (e.g. “Tower of Babel”) 502, wherein one source of transmission/reception could be used for signals. The closest realistic example of this would be a satellite capable of covering a large portion of the earth. Cellular networks 504 are next shown, having standard cells or micro cells. As already mentioned, each cell would require a transmission station, which is generally difficult to install and maintain. The present invention would instead provide a massively parallel network 506. Each base station (also known as the Data Service Terminal shown above) would be capable of covering and servicing a much smaller area (i.e., 1 cell per square mile, or less). As more and more users purchase base stations, the parallel network would grow and the “cells” would effectively become smaller and smaller. The smaller the cell, the better the coverage for any individual utilizing the system.

Accordingly, the network would be comprised of a “minimum user” base station cells spread throughout the service provider area by users of the network. The cells would be connected to the existing service provider using land lines already in existence. The handsets and base stations might have a range of approximately 1 mile and therefore a user would require a base station cell to be relatively close.

The cost to the user of being a “member” of the network is among the following: (1) The purchase of the handset and base station (wherein the two could be sold together in retail stores); (2) Connection to a service provider, wherein the residence or business would be connected to a land line. The connection of the base unit would thereby activate the handset for use within a specified range of all base units in the network. Activation of the base unit will also provide service to all other users in the network; (3) Payment for calls made on the network as determined by the service provider, as well as monthly charges for the land line connection.

Certain aspects of the network include (but are not limited to) the following: proximate user cells; ability of one portable telephone to communicate with all portable telephones in the network (i.e., town wide, state wide, country wide); call initiation format (see below); use of existing land line network, in conjunction with low-cost base station and handsets, to convert devices into a cellular network. The cordless telephone base unit might further offer the following capabilities: the ability to communicate with all handsets on the network; communication with existing land line telephone equipment for billing purposes and low cost; cells having minimum user capacity; and activation by the service provider. Further, the telephone hand units might provide: the capability to communicate with all base stations in the service area; a unique pin code programmable by the service provider through the base station unit. Note that minimum user cell is defined by the maximum capacity of users that are capable of transmission over a single connection to the existing service provider.

FIG. 6 next shows an example of a polling channel schematic (or block diagram) 600. This diagram shows a spread spectrum time division multiple access (TDMA) or CDMA polling schematic, but is not intended to be limited to such. Note that each handset can talk to every base station within its region of compatibility. Note that handset 1 (602) is capable of communicating with base 1 (604) and base 2 (606). Handset N (608) might be capable of communicating with base n (610), and any others along the network within its capabilities. All handsets and base stations communicate with each other on the polling channel. The actual call is placed with both the handset and the base station moving to an empty talk channel.

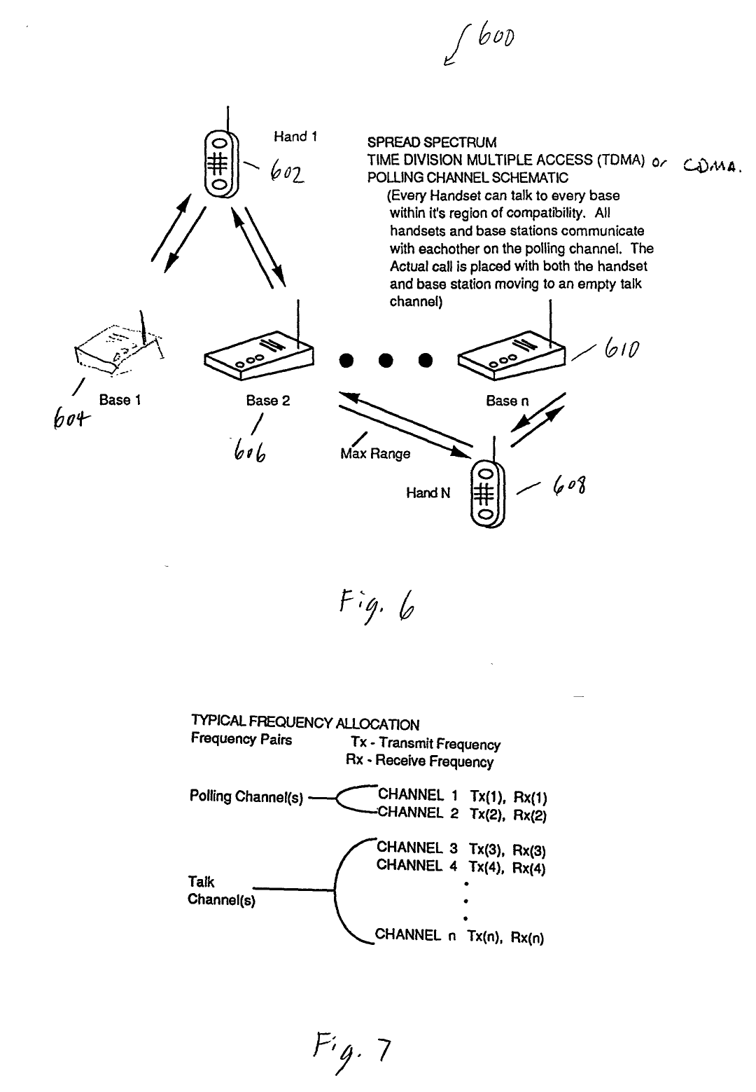

FIG. 7 next shows an example of a typical frequency allocation. The frequency pairs would include Tx (Transmit Frequency) and Rx (Receive Frequency). According to this example, channels 1 and 2 have been allocated as polling channels. Channels 3 through “n” are thereafter allocated as talk channels.

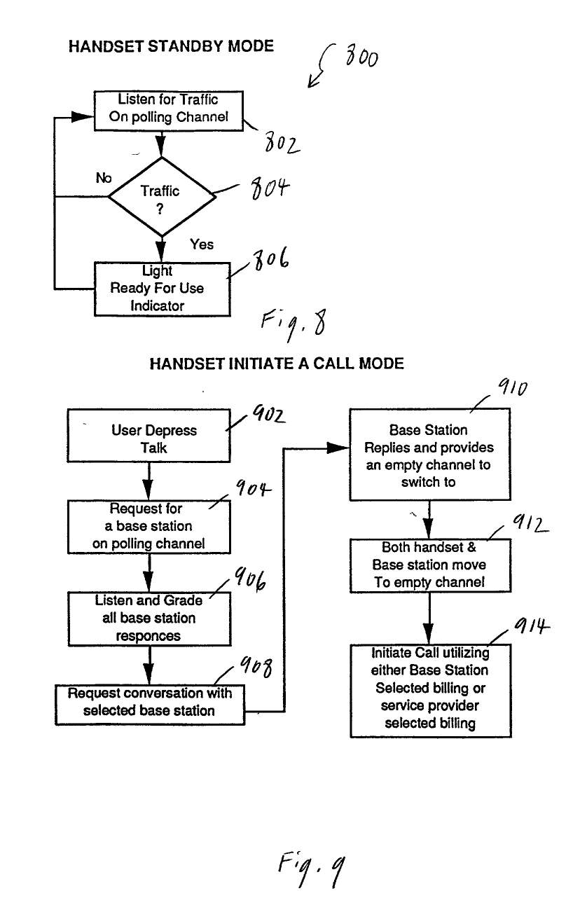

FIG. 8 next shows a representative flow chart 800 of a handset in its standby mode. In step 802, the handset listens for traffic on the polling channel. Decision block 804 inquires whether traffic exists. If “no”, then control returns to step 802 to continue listening for traffic. If “yes”, then the handset will turn on a light (or other such indicator) showing that it is ready for use.

FIG. 9 next shows a representative flow chart 900 of a handset in the mode of initiating a call. In step 902, the user depresses the talk button on the handset. In step 904, a request is sent out by the handset for all base stations in the area to respond on a polling channel. The handset then waits for responses from all of the base stations in the area which respond with an ID code. In step 906, the handset listens to all the responses and grades the responses as a function of receive power level (or the like) for the best possible base station to be used. In step 908, the handset requests conversation with a selected base station using the base station's ID code. In step 910, the base station replies and provides an empty channel for which the handset to switch. In step 912, both the handset and the base station move to the empty channel. In step 914, a call is initiated utilizing either the selected billing of the base station, or billing selected by the service provider.

For instance, one scheme might be similar to a pay telephone call with “0”+area code+telephone#+pin code. Another scheme might be similar to a “1-800” telephone call with “1800” (service provider)+telephone number+pin code. The call is connected, and the user completes the call, and then hangs up. Since the billing information is part of the telephone call and is interfaceable to the existing service provider's hardware, then no provider recognition is required. As a result, the service provider does not have to pay for his own frequencies from the Federal Communications Commission (FCC) because all the equipment is owned and operated by consumers as provided by the FCC rules governing 900 megahertz and 2.4 gigahertz spread spectrum.

The resultant system is very robust in that provides at least to following: (a) Increases the capacity of residential lines currently unused and eases the requirement for more area codes because of its increased capacity; (2) Each owner of a cordless telephone designed to meet this format has the ability to access every base unit in the network free of additional charge; (3) The telephone company benefits in increased line usage and is inexpensively brought into a wireless network; (4) No need to buy spectrum; (5) No need for the telephone company to install cells; (6) Low cost to customers is reflected in their bill as caused by the low build out costs; and (7) The system configuration that gets more robust as the number of users grows (i.e., more base stations installed by users). (8) A universal wireless handset protocall independent of service provider interface will allow for the introduction of new telephony and data services, transparent to the user.

Referring again to FIG. 3, the handsets (308-312) might offer a variety of unique features based upon the functionality of the present system, including for instance: A minimum feature set might be designed for the teen market. Offered is a full featured phone with free local calling. This wireless device will be capable of operation within the MPN network and have a restricted calling area. The handset will not be capable of communications when traveling at speeds above 10 MPH. This is also a new market for wireless devices other than pagers. A medium Feature Set may be designed for a next level of young consumers (i.e., Generation X). The device might combine free local calling and data services (internet/MP3 etc). This device will appeal to a general desire for communication/music/& low cost high technology in one communication package. A high End feature set will include Cellular/PCS for operation while driving and will provide a seamless transition from the home network to the existing wireless infrastructure.

Still another feature that might be offered by the present system is free local calling country wide. Since calls are initiated from a local telephone, the service provider does not charged for such calls. Therefore one could conceivably use this telephone on the other side of the country and still be able to make a local business transaction (in their home area) without having to pay for the privilege of making a local phone call many miles away from home.

The network offered by the present system is also not bound by 10 digit addressing. As such, each each handset will be individually registered with its own ID. The ID is user configurable and not attached to any existing telephony infrastructure. Calls to a handset on the network are performed using the techniques herein. Instead of dialing a 10 digit number (which might be difficult to remember) a user will use an alphanumeric ‘tag’ such as ‘Grandma Smith.’ The network is also backward compatible and therefore will also accept the original ten-digit telephone number.

In general, the present system will be inexpensive to own and operate. For approximately the price of a high end cordless phone, consumers can purchase a ‘starter set’ consisting of a single base unit and a single handset. Once a residence or business has a base unit billing address, additional handsets may be purchased at a fraction of the cost to add to the network. Moreover, the hardware is Consumer Owned and Operated. Market penetration is performed through advertising and the like. Additionally, since the public is known to replace existing cordless phones approximately every 2-3 years, the network should automatically be updated at approximately this same rate.

1. An apparatus for providing a wireless communication network in association with a landline network, the apparatus comprising:
a plurality of base station transceivers forming a network, each base station having a wireless transceiver and a connection to the landline network; and
a plurality of wireless handsets, each of which can communicate with any of the plurality of base stations within range of the handset,
wherein the handset establishes communication with a base station and thereby gains communicative access to the associated landline network through the base station connection.
